(19) United States
(12) Patent Application Publication
(10) Pub. No.: US 2021/0259201 A1
(43) Pub. Date: Aug. 26, 2021

(54) CAT MAT

(71) Applicant: JIOU-JIU LIN, KAOHSIUNG CITY (TW)

(72) Inventor: JIOU-JIU LIN, KAOHSIUNG CITY (TW)

(21) Appl. No.: 16/795,704

(22) Filed: Feb. 20, 2020

(51) Int. Cl. A01K 1/035; B32B 7/12; B32B 5/02; B32B 27/06; B32B 25/04

(52) U.S. Cl. CPC A01K 1/035; B32B 7/12; B32B 2471/04; B32B 27/06; B32B 25/04; B32B 5/022

(57) ABSTRACT

A cat mat is disclosed herein. It comprises a cushion body, a cat grass layer disposed at a top of the cushion body, and a wear resistant layer disposed at a top of the cat grass layer and having a plurality of through holes.

### BACKGROUND OF THE INVENTION

### 1. Field of the Invention

The present invention relates to a cat mat which can draw cats to rest at a specific area and relieve the stress on cats, thereby increasing the convenience of rearing cats.

### 2. Description of Related Art

With the increase of population ageing rate and the decline of total fertility rate (a.k.a. sub-replacement fertility), people like to keep pets, e.g. cats or dogs, to accompany them and increase the joy of life. Pet owners usually set up a dog house outdoors or a box-shaped container indoors for the dogs or cats to rest and sleep.

However, when the conventional box-shaped container is used, it may cause the cat to be uncomfortable and anxious as the cat is confined to a limited space. Therefore, the cat do not like to rest in the area arranged or designated by the pet owner, but instead look for other places they like. Additionally, because the cat's body is covered with thick hair and has the nature of scratching objects and grinding its paws, if the cat is allowed to rest arbitrarily in an indoor environment, it may easily cause environmental pollution and damage to the objects.

### SUMMARY OF THE INVENTION

In view of the above-mentioned problems, the object of the present invention is to provide a cat mat which can draw cats to rest at a specific area and relieve the stress on cats, thereby increasing the convenience of rearing cats.

The cat mat comprises a cushion body, a cat grass layer disposed at a top of the cushion body, and a wear resistant layer disposed at a top of the cat grass layer. The wear resistant layer is provided with a plurality of through holes.

According to an embodiment of the present invention, the cushion body is shaped as a block.

According to an embodiment of the present invention, the cat mat further comprises a seam layer to firmly bond and cover a periphery of the cushion body, the cat grass layer and the wear resistant layer so that the cushion body, the cat grass layer and the wear resistant layer are fixedly combined.

According to an embodiment of the present invention, the cushion body is a non-slip and flexible flake.

According to an embodiment of the present invention, the cushion body is provided with at least one positioning member at a bottom thereof.

According to an embodiment of the present invention, the at least one positioning member is a Velcro.

Accordingly, the smell exuded by the cat grass layer of the present invention draws cats to rest on the cat mat so as to prevent indoor environment pollution and damage to objects caused by cat resting, sleeping, scratching, or excreting arbitrarily. Furthermore, the smell of cat grass also relieves the stress and calms down cats, so the present invention increases the convenience of cat care and rearing.

### BRIEF DESCRIPTION OF THE DRAWINGS

FIG. 1 is a partial enlarged stereogram showing a first embodiment for a cat mat according to the present invention;

FIG. 2 is a cross-sectional view showing a cat mat according to the present invention;

FIG. 3 is a cross-sectional view showing a second embodiment for a cat mat according to the present invention;

FIG. 4 is a cross-sectional view showing a third embodiment for a cat mat according to the present invention.

### DETAILED DESCRIPTION OF THE PREFERRED EMBODIMENT

Hereinafter, an exemplary embodiment of the present invention will be described in detail with reference to the accompanying drawings.

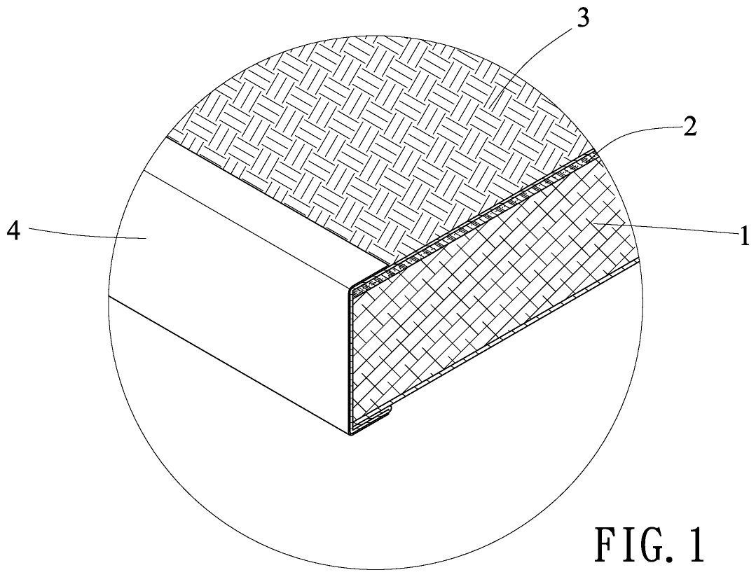

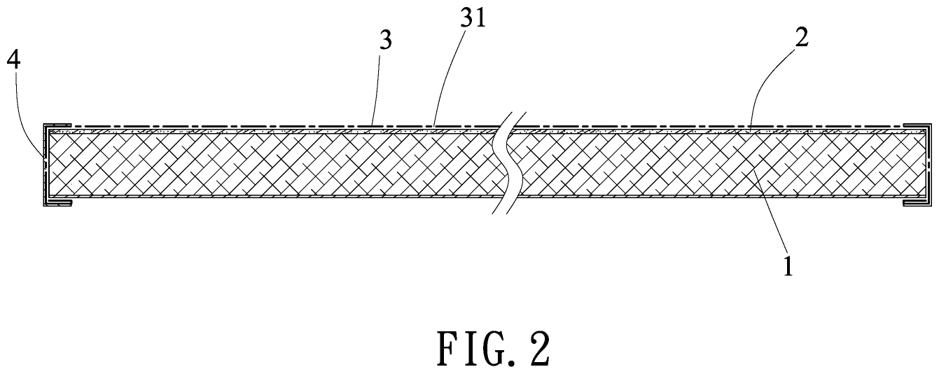

As showed in FIG. 1 and FIG. 2, a first embodiment for a cat mat according to the present invention is disclosed herein. It comprises a cushion body (1), a cat grass layer (2) disposed at a top of the cushion body (1), and a wear resistant layer (3) disposed at a top of the cat grass layer (2). The wear resistant layer (3) is provided with a plurality of through holes (31). Preferably, the cushion body (1) is shaped as a block, e.g. tatami. The wear resistant layer (3) can be made of plastic, rubber, non-woven or synthetic materials. Furthermore, a periphery of the cushion body (1), the cat grass layer (2) and the wear resistant layer (3) is surrounded by a seam layer (4) so that the cushion body, the cat grass layer and the wear resistant layer are fixedly combined.

Accordingly, when the cat mat is placed in a desired position and in contact with the ground, the smell of the cat grass layer (2) exuded from the plurality of through holes (31) of the wear resistant layer (3) draws cats to spontaneously walk to the cat mat for rest which prevent indoor environment pollution and damage to objects caused by cat resting, sleeping, scratching, or excreting arbitrarily. Furthermore, the wear resistant layer (3) has the characteristics of wear resistance and scratch resistance, which can prevent the cat mat from being easily damaged due to scratching by cats and increase the service life of the cat mat.

Different from the box-shaped container, the cat mat does not confine the cat in a limited space and therefore does not make the cat feel uncomfortable. Furthermore, the smell of cat grass can relieve the stress and calm down cats to make them happy and prevent negative emotions from adversely affecting their health. Therefore, the present invention increases the convenience of cat care and rearing.

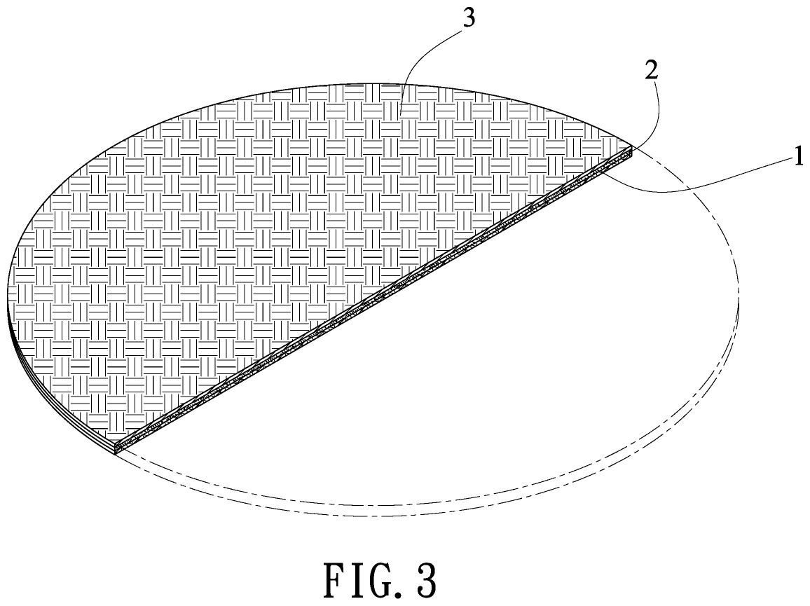

Referring to FIG. 3, a second embodiment for a cat mat according to the present invention is also disclosed. The cushion body (1) is a non-slip and flexible flake and can be made of plastic, rubber or the like. The cat grass layer (2) is disposed at the top of the cushion body (1), and the wear resistant layer (3) is disposed at the top of the cat grass layer (2). Preferably, the cushion body (1) is bonded to the cat grass layer (2) and the wear resistant layer (3) by an adhesive so as to form a simple cat mat with moderate volume, less thickness and light weight. In this way, after the cat mat is laid on a specified position, e.g. on the ground, table, or chair, the cushion body (1) having a non-slip feature allows the cat mat to be stably set on the ground, table, or chair without sliding. Then, the smell exuded by the cat grass layer (2) attracts cats to spontaneously walk to the cat mat to rest.

If the pet owner wants to take the cat out, the cat mat that is thin, flexible and foldable can also be carried out for the cat to dine or rest outdoors and thus prevent outdoor environment pollution and damage to objects caused by cats running, sleeping, scratching, or excreting arbitrarily.

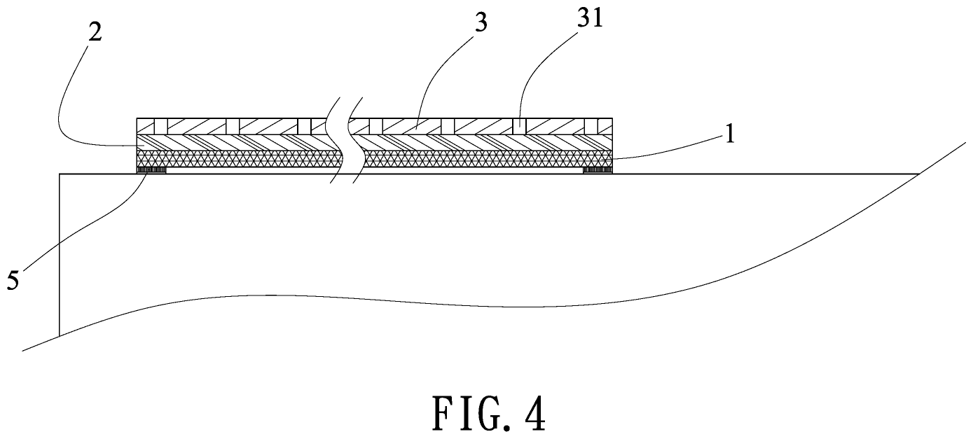

Referring to FIG. 4, a third embodiment for a cat mat according to the present invention is also disclosed. The bottom of the cushion body (1) shaped as the flake is further provided with at least one positioning member (5) which is bonded by an adhesive. Preferably, the at least one positioning member (5) is a Velcro, and another positioning unit which can be correspondingly combined with the at least one positioning member (5) (Velcro) is also provided on the ground, table or chair. Therefore, the cat mat is stably set on the ground, table, or chair to improve the safety of cats resting on the cat mat.

According to the above description, in comparison with the traditional technique, the present invention has the advantages as following:

1. The cat mat having the cat grass layer on the cushion body draws cats to rest on the cat mat so as to prevent indoor or outdoor environment pollution and damage to objects caused by cat running, sleeping, scratching, or excreting arbitrarily.

2. The present invention has moderate volume, less thickness, and light weight through the flake-shaped cushion body, the cat grass layer, and the wear resistant layer, so it can be easily laid on the ground, a tabletop or a chair surface to attract cats to spontaneously walk to the cat mat to rest.

3. The flake-shaped cushion body having flexibility can be easily folded and carried out for cats to dine or rest outdoors if the pet owner wants to take cats out. Therefore, the present invention has convenience in use.

4. The wear resistant layer disposed on the cushion body can prevent the cat mat from being easily damaged due to scratching by cats and thereby increase the service life of the cat mat.

5. The cat mat does not confine cats in a limited space and thereby does not make the cats feel uncomfortable. Furthermore, the smell of cat grass can relieve the stress and calm down cats to prevent negative emotions from adversely affecting their health.

What is claimed is:

1. A cat mat, comprising a cushion body, a cat grass layer disposed at a top of the cushion body, and a wear resistant layer disposed at a top of the cat grass layer and having a plurality of through holes.

2. The cat mat as claimed in claim 1, wherein the cushion body is shaped as a block.

3. The cat mat as claimed in claim 2, further comprising a seam layer to firmly bond and cover a periphery of the cushion body, the cat grass layer and the wear resistant layer.

4. The cat mat as claimed in claim 1, wherein the cushion body is a non-slip and flexible flake.

5. The cat mat as claimed in claim 4, wherein the cushion body is provided with at least one positioning member at a bottom thereof.

6. The cat mat as claimed in claim 5, wherein the at least one positioning member is a Velcro.
